(19) United States
(12) Patent Application Publication
(10) Pub. No.: US 2026/0042149 A1
(43) Pub. Date: Feb. 12, 2026

(54) THREAD TURNING CUTTING INSERT HAVING A CUTTING PORTION WITH THREE CUTTING TEETH AND CUTTING TOOL

(71) Applicant: ISCAR, LTD., TEFEN (IL)

(72) Inventors: VITALY OREN, KFAR VRADIM (IL); YURI SORKIN, KARMIEL (IL); VLADMIR KOREN, MAALOT (IL)

(73) Assignee: ISCAR, LTD., TEFEN (IL)

(21) Appl. No.: 18/796,973

(22) Filed: Aug. 7, 2024

(51) Int. Cl. B23B 27/06

(52) U.S. Cl. CPC B23B 27/065; B23B 2200/08; B23B 2270/16

(57) ABSTRACT

A cutting tool for thread cutting has a thread turning cutting insert releasably retained in an insert pocket by a fastening member. The thread turning cutting insert has a thread cutting portion having three spaced apart cutting teeth. and a chip forming groove recessed in an insert upper surface. The chip forming groove includes a near-flank groove surface close to the cutting teeth and far-flank grove surface further away from the cutting teeth. The thread cutting portion includes three cutting edges formed at the intersection of the insert upper surface and an insert peripheral surface. Each cutting edge is located on a respective cutting tooth. The thread cutting portion includes three planar land surfaces located on the insert upper surface. Each land surface extends from an entire length of a respective cutting edge to the near-flank groove surface.

### FIELD OF THE INVENTION

The subject matter of the present application relates to thread turning cutting inserts (sometimes referred to as “threading inserts”) for thread turning cutting tools, designed for cutting a thread in a workpiece, and in particular to thread turning cutting inserts of the type having a cutting portion with three cutting teeth, and further in particular to cutting teeth having a land.

### BACKGROUND OF THE INVENTION

A cutting tool for thread turning metalworking operations may comprise a thread turning cutting insert removably attached to an insert holder. More precisely, the thread turning cutting insert has a cutting portion with multiple cutting teeth.

In some such thread turning cutting tools, the cutting portion is located along a side (i.e., non-corner) surface of the cutting insert. One example of such a cutting tool is disclosed in, for example, U.S. Pat. No. 4,572,713, which discloses a thread cutting insert comprising parallel side surfaces and two mutually adjacent edge surfaces, which are provided with cutting teeth and extend between the side surfaces. A recess acting as a chip breaker is provided in the side surface in connection with cutting teeth. Another example is U.S. Pat. No. 5,549,425 which discloses a two cutting edge, indexable insert with integral pressed-in chip breaker wherein the cutting edges are symmetrically inverted relative to each other to thereby provide indexing therebetween. Each cutting edge is provided with a plurality of noses and gullets. The shape of the noses and gullets is predetermined to provide a predetermined thread contour. First and second chip breakers are each recessed from their respective first and second cutting edge and are each contoured to correspond to the aforementioned noses and gullets thereof. The recess of each of the first and second chip breakers from their respective first and second cutting edge is defined by the first and second lands, respectively.

In other thread turning cutting tools, the cutting portion is located at a corner of the cutting insert. One example of such a cutting tool is disclosed in, for example, U.S. Pat. No. 4,575,888, which discloses a triangular shaped cutting insert having three cutting corners. Each cutting corner is provided with three cutting tips. The number of cutting tips may be changed to two or four. Each cutting tip has two cutting edges and primary phases connected thereto. The primary phases either have a constant width or taper in direction from a nose part. Another example is U.S. Pat. No. 6,138,540, which discloses a cutting insert with three cutting corners. Each cutting corner comprises a leading first cutting insert tip, a trailing second cutting insert tip, a cutting edge which runs along the intersection of a chip surface and a clearance surface, and a chip breaker rim. Yet another example is WO2022259104A1 which discloses a cutting insert including at least one and preferably, three generally triangular shaped cutting protrusions. In some embodiments, each of the cutting protrusion may comprise a variable number of protruding tips, in the form of a plurality of cutting teeth. A rake face includes a tip flat which extends between a rake front at a protrusion tip towards a rake root portion, adjacent the primary body. In a preferred embodiment, the protrusion tip is defined only by a central arc shaped flank surface of a protruding flank. In other embodiments, the protrusion tip is defined by the entire surface of the protruding flank such that the protrusion tip is defined at the entire periphery of the cutting protrusion.

It is an object of the subject matter of the present application to provide a new and improved cutting tool.

It is a further object of the subject matter of the present application to provide a cutting tool with improved tool life.

It is a yet further object of the subject matter of the present application to provide a cutting tool which can cut a thread in only two passes.

### SUMMARY OF THE INVENTION

In accordance with a first aspect of the subject matter of the present application there is provided a thread turning cutting insert having an insert central axis and comprising:
opposite insert upper and lower surfaces and an insert peripheral surface extending therebetween about the insert central axis; and
at least one thread cutting portion comprising:
   three spaced apart, non-identical cutting teeth which differ from one another in shape and/or size, the three cutting teeth protruding outwardly from the insert peripheral surface in a common tooth protruding direction, the three cutting teeth being arranged sequentially along a teeth arrangement axis which defines a teeth arrangement direction and comprising a roughing tooth, a finishing tooth and a semi-finishing tooth located therebetween, the roughing tooth being forward of the semi-finishing tooth and the semi-finishing tooth being forward of the finishing tooth with respect to the teeth arrangement direction;
   three cutting edges formed at the intersection of the insert upper surface and the insert peripheral surface, each cutting edge being located on a respective cutting tooth;
   a chip forming groove recessed in the insert upper surface, the chip forming groove extending along a groove axis and comprising opposite near-flank and far-flank groove surfaces which converge towards each other, the near-flank groove surface being closer to the three cutting teeth than the far-flank groove surface; and
   three planar land surfaces, each extending from an entire length of a respective cutting edge to the near-flank groove surface, thereby defining a land border line.

In accordance with a second aspect of the subject matter of the present application there is provided a cutting tool having a feed axis defining a feed direction, and an infeed axis oriented transversely to the feed axis and defining an infeed direction, the cutting tool comprising:
an insert holder having a holder longitudinal axis defining opposite forward and rearward direction, the insert holder comprising an insert pocket located at a forward end thereof; and
a thread turning cutting insert, of the type described above, releasably retained in the insert pocket.

In accordance with a third aspect of the subject matter of the present application there is provided a method for cutting a thread in a workpiece surface on a workpiece by means of a cutting tool of the type described above, wherein:
the thread has a thread depth;
the workpiece has a centerline defined by a diameter thereof; and
the cutting edge on each cutting tooth comprises two tooth flank cutting edges and a tooth nose cutting edge extending therebetween;
the method comprising:
   rotating the workpiece about a workpiece rotational axis in a rotational direction;
   positioning the cutting tool so that, in a view along the workpiece rotational axis, the tooth nose cutting edge of the roughing tooth touches the workpiece surface at the centerline;
   performing a first pass by moving the cutting tool and/or the workpiece relative to each other along the feed axis in the feed direction, the first pass being performed at a first pass cutting depth;
   performing a second pass by moving the cutting tool and/or the workpiece relative to each other along the feed axis in the feed direction, the second pass being performed at a second pass cutting depth; wherein:
   the first pass cutting depth and the second pass cutting depth satisfy the condition:

2.5*CD₂≤CD₁≤3.5*CD₂.

It is understood that the above-said is a summary, and that features described hereinafter may be applicable in any combination to the subject matter of the present application, for example, any of the following features may be applicable to the thread turning cutting insert or the cutting tool or the method for cutting the thread:

At least one cutting tooth can have a tooth protruding axis which defines the common tooth protruding direction. The at least one thread cutting portion has a border plane oriented perpendicular to the tooth protruding axis which can contain the land border line.

The groove axis can be oriented parallel to the border plane.

In a top view of the at least one thread cutting portion, the roughing tooth and the semi-finishing tooth can be spaced apart by a roughing tooth gap. The semi-finishing tooth and the finishing tooth can be spaced apart by a semi-finishing tooth gap. The border plane can intersect at least one of the roughing tooth gap and the semi-finishing tooth gap, so that the land border line is non-continuous.

The border plane can intersect the roughing tooth gap. The land surfaces on the roughing tooth and the semi-finishing tooth can be spaced apart.

The cutting edge on each cutting tooth can comprise two tooth flank cutting edges and a tooth nose cutting edge extending therebetween.

The two tooth flank cutting edges on all the three cutting teeth can be straight.

The tooth nose cutting edge on the roughing tooth can comprise two tooth nose cutting edge extremities and a tooth nose cutting edge mid-potion extending therebetween. The tooth nose cutting edge mid-potion can be straight.

The tooth nose cutting edge on the semi-finishing tooth can be defined by a semi-finishing radius. The tooth nose cutting edge on the finishing tooth can be defined by a finishing radius. The finishing radius can be less than the semi-finishing radius.

The tooth flank cutting edges on the roughing tooth can define a roughing angle. The tooth flank cutting edges on the semi-finishing tooth can define a semi-finishing angle. The tooth flank cutting edges on the finishing tooth can define a finishing angle. The semi-finishing angle can be less than the roughing angle and the finishing angle.

At least one cutting tooth can be a tooth protruding axis which defines the common tooth protruding direction. Each cutting tooth has a minimum tooth length measured in the tooth protruding direction along the tooth protruding axis. For any given cutting tooth, the land surface can extend between the two tooth flank cutting edges and can also extend from the tooth nose cutting edge, in a direction opposite the tooth protruding direction, further than 50% of the minimum tooth length.

The finishing tooth can protrude further in the tooth protruding direction than the semi-finishing tooth. The semi-finishing tooth can protrude further in the tooth protruding direction than the roughing tooth.

The land surfaces on the three cutting teeth can be co-planar. The land border line can be a straight line.

The at least one thread cutting portion can comprise exactly three cutting teeth.

The thread turning cutting insert can comprise at least three identical thread cutting portions circumferentially spaced apart about the insert central axis. The insert peripheral surface can comprise at least three insert side surfaces and at least three insert corner surfaces alternating therewith, the at least three insert side surfaces comprising at least three insert side abutment surfaces. Each insert side surface can have a respective insert side abutment surface located thereon. In each thread cutting portion, the three cutting teeth can protrude outwardly in said common tooth protruding direction, from a respective insert corner surface or a respective insert side surface.

In each thread cutting portion, the three cutting teeth can protrude outwardly from a respective insert corner surface.

The at least three insert side surfaces can comprise exactly three insert side surfaces and the at least three insert corner surfaces can comprise exactly three insert corner surfaces.

The thread turning cutting insert can have an insert plane oriented perpendicular to the insert central axis and intersecting the land border line. The chip surface and the insert plane can define a rake angle. Each land surface and the insert plane can define a land angle. The land angle can be less than the rake angle.

The land angle can satisfy the condition: 0°≤β≤5°. Preferably, the land angle can be equal to 0°.

At least one cutting tooth can have a tooth protruding axis which defines the common tooth protruding direction. The insert central axis, the teeth arrangement axis and the tooth protruding axis can be mutually perpendicular to each other.

The teeth arrangement direction can be co-directional with the feed direction.

The thread turning cutting insert has an insert median plane oriented perpendicular to the insert central axis and extending mid-way between the insert upper and lower surfaces. The insert median plane is oriented transversely to the holder longitudinal axis. For any given cutting tooth of an active thread cutting portion, in a side view of the cutting tool along the feed axis, the land surface and a tool plane oriented parallel to the holder longitudinal axis and intersecting the land border line can define an effective land angle. The effective land angle can be less than 0°.

The first pass cutting depth and the second pass cutting depth can satisfy the condition: CD₁=3*CD₂.

The centerline can be oriented in the infeed direction. The first pass cutting depth and the second pass cutting depth can satisfy the condition: CD₁+CD₂=DT.

### BRIEF DESCRIPTION OF THE FIGURES

For a better understanding of the present application and to show how the same may be carried out in practice, reference will now be made to the accompanying drawings, in which:

FIG. 1 is a perspective view of a cutting tool in accordance with the present invention;

FIG. 2 is a perspective exploded view of the cutting tool shown in FIG. 1;

FIG. 3 is a perspective view of a cutting insert shown in FIG. 1;

FIG. 4 is a bottom view of the thread turning cutting insert shown in FIG. 3;

FIG. 5 is a top view of the thread turning cutting insert shown in FIG. 3;

FIG. 6 is a detail of FIG. 5;

FIG. 7 is a side view of the thread turning cutting insert shown in FIG. 3, along a groove axis;

FIG. 8 is a cross section view taken along lines VIII-VIII shown in FIG. 5;

FIG. 9 is a top view of the cutting tool and a workpiece, illustrating a method for cutting a thread on the workpiece by performing a first pass and a second pass;

FIG. 10 is a side view of the cutting tool and the workpiece;

FIG. 11A is a schematic view of a roughing tooth contour, a semi-finishing tooth contour and a finishing tooth contour superimposed on each other, during the first pass, with respect to a final thread contour; and

FIG. 11B is an analogous view shown in FIG. 11A, during the second pass.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Where considered appropriate, reference numerals may be repeated among the figures to indicate corresponding or analogous elements.

### DETAILED DESCRIPTION OF THE INVENTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

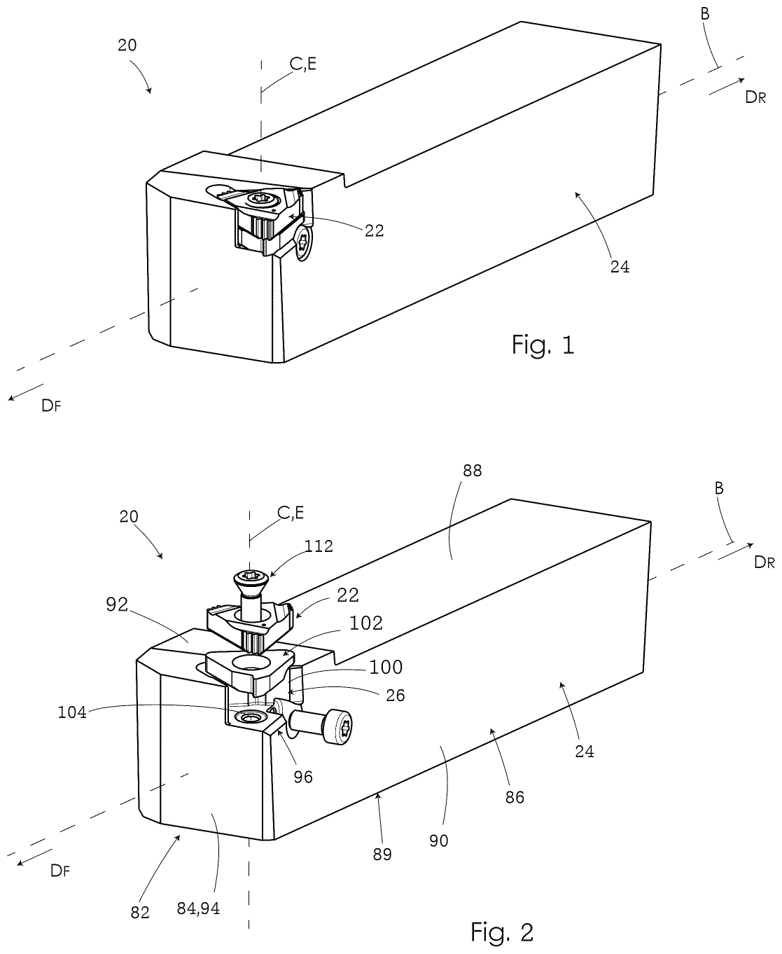

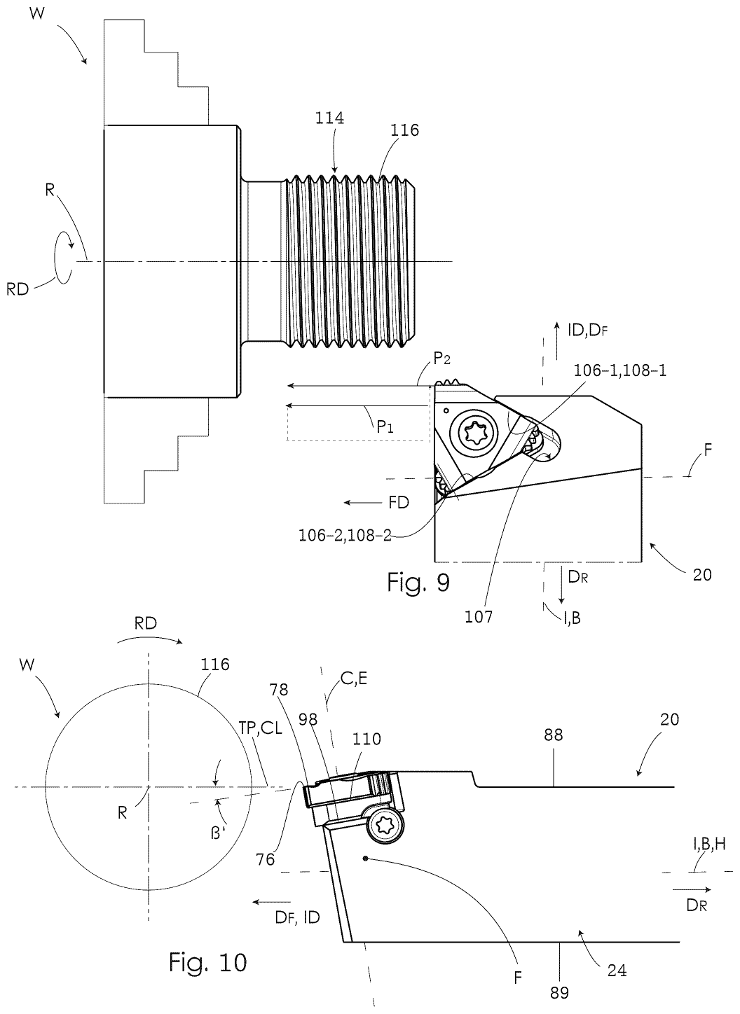

Attention is first drawn to FIG. 1 showing a cutting tool 20. The cutting tool 20 is of the type used for threading, more precisely thread turning, in accordance with an embodiment of the subject matter of the present application. The cutting tool 20 has a replaceable thread turning cutting insert 22 and an insert holder 24. The cutting tool 20 is adjustable between an assembled position and an unassembled position. In the assembled position of the cutting tool 20, the thread turning cutting insert 22 is removably retained in an insert pocket 26 of the insert holder 24. In this non-limiting example shown in the drawings, the cutting tool 20 is a right-handed cutting tool. As seen in FIG. 9, the cutting tool 20 has a feed axis F which defines a feed direction FD. The feed direction FD is the direction in which the cutting tool 20 moves relative to a workpiece W as the latter rotates about a workpiece rotational axis R, when performing a linear thread turning operation on the rotating workpiece W. Generally speaking, the feed axis F is parallel to the workpiece rotational axis R. As seen in FIGS. 9 and 10, the cutting tool 20 has an infeed axis I which defines an infeed direction ID. The infeed axis I is oriented transversely to the feed axis F. The infeed direction ID is the direction in which the cutting tool 20 moves in order to adjust the cutting depth between passes on the workpiece W, and is preferably radially directed with respect to a workpiece rotational axis R.

Making reference to FIGS. 3 to 7, a first aspect of the subject matter of the present application relates to the thread turning cutting insert 22. The thread turning cutting insert 22 is made of a hard material. For example, the thread turning cutting insert 22 may be made of cemented carbide.

The thread turning cutting insert 22 includes opposite insert upper and lower surfaces 28, 30 and an insert peripheral surface 32 which extends therebetween. The thread turning cutting insert 22 has an insert central axis C. The insert peripheral surface 32 extends circumferentially about, and faces away from the insert central axis C. In accordance with some embodiments of the subject matter of the present application, the insert upper surface 28 can include a planar insert upper central surface 33. The insert lower surface 30 can include a planar insert lower base surface 34. The insert upper central surface 33 and the insert lower base surface 34 can be oriented perpendicular to the insert central axis C. The thread turning cutting insert 22 has an insert median plane M oriented perpendicular to the insert central axis C and which extends mid-way between the insert upper and lower surfaces 28, 30.

In accordance with some embodiments of the subject matter of the present application, the thread turning cutting insert 22 can include a through hole 36, for receiving a fastening member 112 (e.g., a clamping screw as discussed later in the description). The through hole 36 can extend along the insert central axis C. The through hole 36 can open out to the insert upper and lower surfaces 28, 30.

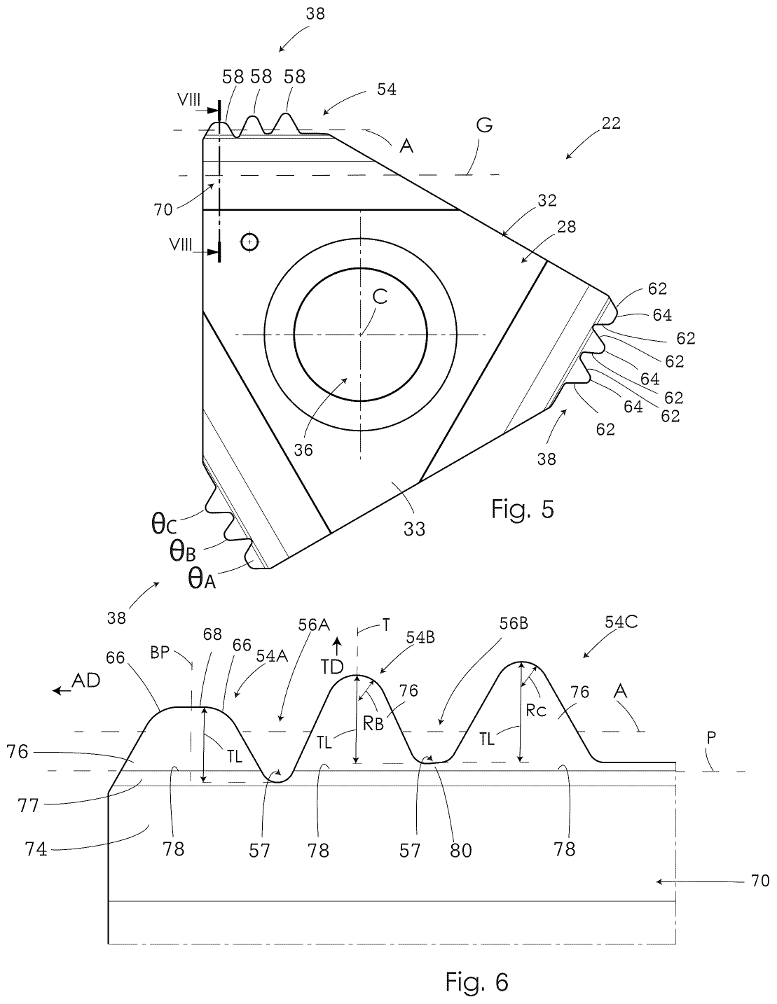

Referring to FIG. 5, the thread turning cutting insert 22 has a polygonal basic shape defined by at least three insert corner portions 38. The insert upper and lower surfaces 28, 30 also have a corresponding polygonal basic shape. In accordance with some embodiments of the subject matter of the present application, the thread turning cutting insert 22 can exhibit N-fold rotational symmetry about the insert central axis C, where N is a positive integer greater than or equal to three. In this non-limiting example shown in the drawings, N=3, i.e., the thread turning cutting insert 22 has triangular shape defined by exactly three insert corner portions 38.

The insert peripheral surface 32 includes at least three insert side surfaces 44. The insert peripheral surface 32 includes at least three insert corner surfaces 46 formed at the insert corner portions 38. The at least three insert side surfaces 44 alternate with the at least three insert corner surfaces 46. Each insert side surface 44 extends between two adjacent insert corner surfaces 46. In the triangular shaped configuration of the thread turning cutting insert 22, the insert peripheral surface 32 includes exactly three insert side surfaces 44 and exactly three insert corner surfaces 46.

The at least three insert side surfaces 44 include at least three insert side abutment surfaces 48, each insert side surface 44 having a respective insert side abutment surface 48 located thereon. In accordance with some embodiments of the subject matter of the present application, the insert side abutment surfaces 48 can be planar and parallel to the insert central axis C. The insert lower surface 30 includes an insert lower abutment surface 50. The insert lower abutment surfaces 50 is configured for abutting a complementary surface on the insert pocket 26 (which complementary surface could be formed on a shim if one is present).

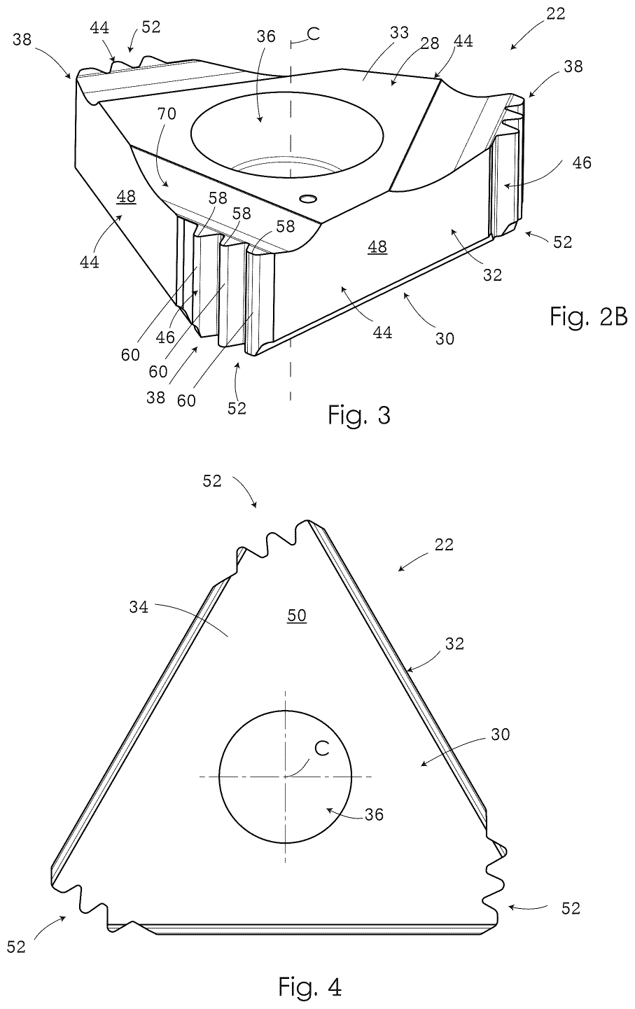

Making reference to FIGS. 3-5, the thread turning cutting insert 22 includes at least one thread cutting portion 52. In accordance with some embodiments of the subject matter of the present application, the thread turning cutting insert 22 can include at least three thread cutting portions 52 circumferentially spaced apart about the insert central axis C. Thus, the thread turning cutting insert 22 can be indexed. In this non-limiting example shown in the drawings, the thread turning cutting insert is three-way indexable by rotation about the insert central axis C. The at least three thread cutting portions 52 can be identical. When the cutting tool 20 is assembled (see FIG. 2) one of the thread cutting portions 52 forms an active thread cutting portion 52 (positioned so as to be able to perform metal cutting operations) and the remaining thread cutting portion 52 form non-active thread cutting portions 52.

The following disclosure refers to one of the thread cutting portions 52 but is applicable to all other thread cutting portion 52 (when present).

The thread cutting portion 52 includes three cutting teeth 54A, 54B, 54C. In accordance with some embodiments of the subject matter of the present application, the thread cutting portion 52 can include exactly three cutting teeth 54A, 54B, 54C. While the three cutting teeth 54A, 54B, 54C are spaced apart from one another along the insert peripheral surface 32, they remain clustered together along a corresponding insert corner surface 46 (as seen in the drawings), though they may be clustered together along a corresponding insert side surface 44. The three cutting teeth 54A, 54B, 54C are non-identical, differing from one another in size and/or shape. They may also differ from one another in orientation.

Referring to FIGS. 4 and 5, the three cutting teeth 54A, 54B, 54C protrude outwardly from the insert peripheral surface 32. Making reference to FIG. 6 (showing a detail of FIG. 5), the three cutting teeth 54A, 54B, 54C protrude outwardly from the insert peripheral surface 32, at least one cutting tooth 54A, 54B, 54C having a tooth protruding axis T, the tooth protruding axis T defining a common tooth protruding direction TD. In the configuration of the thread turning cutting insert 22 having a polygonal basic shape, in each thread cutting portion 52, the three cutting teeth 54A, 54B, 54C can protrude outwardly (in said common tooth protruding direction TD) from a respective insert corner surface 46. In some embodiments, in each thread cutting portion 52, the three cutting teeth 54A, 54B, 54C may protrude outwardly (in said common tooth protruding direction TD) from other portions of a respective insert side surface 44.

Making reference to FIG. 6 again, the three cutting teeth 54A, 54B, 54C are arranged sequentially along a teeth arrangement axis A which defines a teeth arrangement direction AD extending towards an adjoining insert side surface 44. In accordance with some embodiments of the subject matter of the present application, the insert central axis C, the teeth arrangement axis A and any one tooth protruding axis T can be mutually perpendicular to each other.

The three cutting teeth 54A, 54B, 54C include a roughing tooth 54A, a finishing tooth 54C and a semi-finishing tooth 54B located therebetween. The roughing tooth 54A is forward of (i.e., encounters the workpiece first in the feed direction FD, as seen in FIG. 9) the semi-finishing tooth 54B and the semi-finishing tooth 54B is forward of the finishing tooth 54C, all with respect to the teeth arrangement direction AD. In accordance with some embodiments of the subject matter of the present application, the roughing tooth 54A can adjoin one of the insert side surfaces 44.

In a top view of the thread cutting portion 52, the roughing tooth 54A and the semi-finishing tooth 54B are spaced apart by a roughing tooth gap 56A. The semi-finishing tooth 54B and the finishing tooth 54C are spaced apart by a semi-finishing tooth gap 56B. The roughing tooth gap 56A and the semi-finishing tooth gap 56B both terminate (in a direction opposite the tooth protruding direction TD) at a corresponding gap trough portion 57.

Reverting to FIGS. 3 and 5, the thread cutting portion 52 includes three cutting edges 58, configured to perform metal cutting operations, formed at the intersection of the insert upper surface 28 and the insert peripheral surface 32. Each cutting edge 58 is located on a respective cutting tooth 54A, 54B, 54C. Part of the insert peripheral surface 32, and more particularly the insert corner surface 46 (in the embodiment shown in the figures), adjoining and extending away from the three cutting edges 58, serve as relief surfaces 60. The relief surfaces 60 can be oriented parallel to the insert central axis C.

Referring to FIG. 6, in accordance with some embodiments of the subject matter of the present application, each cutting edge 58 can exhibit symmetry about a corresponding tooth bisector plane BP, oriented perpendicular to the teeth arrangement axis A.

In accordance with some embodiments of the subject matter of the present application, the cutting edge 58 on each cutting tooth 54A, 54B, 54C can include two tooth flank cutting edges 62 and a tooth nose cutting edge 64 extending therebetween. The tooth nose cutting edge 64 can be forward from the two tooth flank cutting edges 62 in the tooth protruding direction TD.

In accordance with some embodiments of the subject matter of the present application, the two tooth flank cutting edges 62 on all the three cutting teeth 54A, 54B, 54C can be straight.

In accordance with some embodiments of the subject matter of the present application, the tooth nose cutting edge 64 on the roughing tooth 54A can include two tooth nose cutting edge extremities 66 and a tooth nose cutting edge mid-potion 68 extending therebetween. The tooth nose cutting edge mid-potion 68 can be straight. The tooth nose cutting edge extremities 66 can be outwardly curved. The roughing tooth 4A can have a trapezoidal shape in a top view.

In accordance with some embodiments of the subject matter of the present application, the tooth nose cutting edge 64 on the semi-finishing tooth 54B can be defined by a semi-finishing radius RB. The tooth nose cutting edge 64 on the finishing tooth 54C can be defined by a finishing radius RC. The finishing radius RC can be less than the semi-finishing radius RB.

Making reference to FIG. 5, the tooth flank cutting edges 62 on the roughing tooth 54A define a roughing angle θA. The tooth flank cutting edges 62 on the semi-finishing tooth 54B define a semi-finishing angle θB. The tooth flank cutting edges 62 on the finishing tooth 54C define a finishing angle θC. In accordance with some embodiments of the subject matter of the present application, the semi-finishing angle θB can be less than the roughing angle θA and the finishing angle θC. The roughing angle θA and the finishing angle θC can be equal.

In accordance with some embodiments of the subject matter of the present application, in the configuration where the tooth nose cutting edge 64 on the semi-finishing tooth 54B is defined by a semi-finishing radius RB and the tooth nose cutting edge 64 on the finishing tooth 54C is defined by a finishing radius RC, the semi-finishing angle θB and the finishing angle θC can be different (i.e. non-equal).

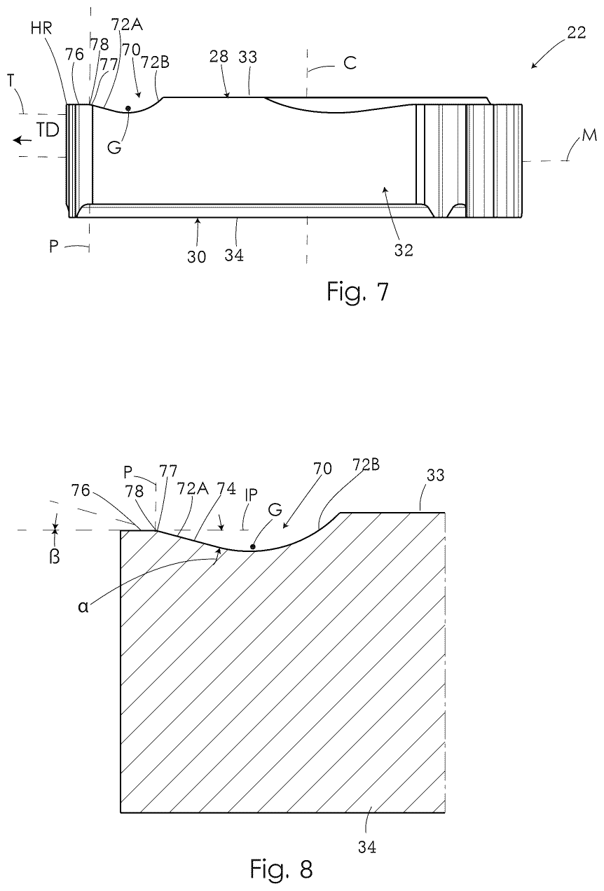

Making reference to FIG. 7, in accordance with some embodiments of the subject matter of the present application, each cutting edge 58 can be honed. Each cutting edge 58 can be roundly honed and have a hone radius HR.

Reverting to FIGS. 5 and 6, the thread cutting portion 52 includes a chip forming groove 70 recessed in the insert upper surface 28. The chip forming groove 70 extends along a groove axis G. The groove axis G may run along the deepest portion of the chip forming groove 70 and be parallel to the teeth arrangement axis A. In accordance with some embodiments of the subject matter of the present application, the chip forming groove 70 can intersect (open out to) two adjacent insert side surfaces 44.

As seen in FIG. 7, the chip forming groove 70 includes opposite near-flank and far-flank groove surfaces 72A, 72B which converge towards each other (in a direction towards the insert median plane M). The near-flank and far-flank groove surfaces 72A, 72B extend along the groove axis G. The near-flank groove surface 72A is closer to the three cutting teeth 54A, 54B, 54C than the far-flank groove surface 72B. In accordance with some embodiments of the subject matter of the present application, the far-flank groove surface 72B can adjoin the insert upper central surface 33.

The near-flank groove surface 72A includes a chip surface 74 (“chip former”). In accordance with some embodiments of the subject matter of the present application, the chip surface 74 can be planar.

The thread cutting portion 52 includes three planar land surfaces 76. The three planar land surfaces 76 are located on the insert upper surface 28. It is noted that each land surface 76 does not extend only from the tooth nose cutting edge 64. Moreover, each land surface 76 does not extend only along a respective cutting edge 58 (i.e., along a periphery of an upper surface of the cutting tooth). Rather, each land surface 76 extends from an entire length of a respective cutting edge 58 (in a direction opposite the tooth protruding direction TD) to the near-flank groove surface 72A. Stated differently, each planar land surface 76 extends between (i.e., connects) the tooth nose cutting edge 64 and the near-flank groove surface 72A and also extends between (i.e., connects) the two tooth flank cutting edges 62. Such a configuration reinforces the cutting edges 58 and improves tool life. In accordance with some embodiments of the subject matter of the present application, the near-flank groove surface 72A can include a narrow (i.e., strip-like) groove intermediate surface 77 which extends between each land surface 76 and the chip surface 74. Thus, the chip surface 74 can be spaced apart from the land surfaces 76. The groove intermediate surface 77 can curve convexly between the land surfaces 76 and the chip surface 74. Alternatively, the groove intermediate surface 77 can be planar. It is noted that the chip surface 74 and the groove intermediate surface 77 can extend along the entire axial length of the chip forming groove 70.

The land surfaces 76 on the three cutting teeth 54A, 54B, 54C can be co-planar.

The land surfaces 76 extend to (i.e. intersect) the near-flank groove surface 72A thereby defining a land border line 78. In accordance with some embodiments of the subject matter of the present application, the thread cutting portion 52 includes a border plane P, oriented perpendicular to the tooth protruding axis T, which can contain the land border line 78.

In the configuration of the thread turning cutting insert 22 having co-planar land surfaces 76, the land border line 78 can be a straight line.

The border plane P can intersect at least one of the roughing tooth gap 56A and the semi-finishing tooth gap 56B, and thus the land border line 78 can be non-continuous (i.e., interrupted/broken). In particular, the border plane P can intersect the roughing tooth gap 56A (and the near-flank groove surface 72A extends onto the roughing tooth 54A and the semi-finishing tooth 54B). Thus, the land surfaces 76 on the roughing tooth 54A and the semi-finishing tooth 54B can be spaced apart. The border plane P can be spaced apart from the semi-finishing tooth gap 56B (and the near-flank groove surface 72A does not extend onto the finishing tooth 54C). Thus, the land surfaces 76 on the semi-finishing tooth 54B and the finishing tooth 54C can be connected by a land connecting surface 80 located on the insert upper surface 28. The land connecting surface 80 can be planar (and co-planar with land surfaces 76).

The chip surface 74 and an insert plane IP, oriented perpendicular to the insert central axis C and intersecting the land border line 78, define a rake angle α. The chip surface 74 decreases in height (i.e. in distance from the insert median plane M) with increasing distance from the land border line 78 at the rake angle α (i.e. the rake angle α is positive). The rake angle α is an acute angle. In accordance with some embodiments of the subject matter of the present application, the rake angle α can satisfy the condition: 10°≤α≤20°. Preferably, the rake angle α is equal to 15°.

Each land surface 76 and the insert plane IP defines a land angle β. In accordance with some embodiments of the subject matter of the present application, the land surface 76 can increase, or be constant, in height (i.e. in distance from the insert median plane M) with increasing distance from the land border line 78 at the land angle β (i.e., the land angle β is positive or neutral, respectively). The land angle β can be an acute angle or a zero angle. The land angle β can satisfy the condition: 0°≤β≤5°. Preferably, the land angle β can be equal to 0°.

The land angle β is less than the rake angle α. That is to say, each land surface 76 is oriented differently than the chip surface 74. In accordance with some embodiments of the subject matter of the present application, for any given cutting edge 58, the land surface 76 can slope less steeply (i.e., at a shallower angle) towards the insert median plane M than the chip surface 74.

In accordance with some embodiments of the subject matter of the present application, the groove axis G can be oriented parallel to the border plane P.

In accordance with some embodiments of the subject matter of the present application, the two tooth flank cutting edges 62 on the roughing tooth 54A can extend to the land border line 78 (and the border plane P).

As seen in FIG. 6, in accordance with some embodiments of the subject matter of the present application, each cutting tooth 54A, 54B, 54C has a minimum tooth length TL measured in the tooth protruding direction TD along the tooth protruding axis T, from a tip of the tooth nose cutting edge 64 to a closest gap trough portion 57 of the cutting tooth's adjacent roughing tooth gap 56A and/or semi-finishing tooth gap 56B.

In accordance with some embodiments of the subject matter of the present application, for any given cutting tooth 54A, 54B, 54C, the planar land surface 76 can extend from the tooth nose cutting edge 64, in a direction opposite the tooth protruding direction TD, further than 50% of the minimum tooth length TL. Preferably, the planar land surface 76 extends further than 75% of the minimum tooth length TL. Further preferably, the land surface 76 extends further than 100% of the minimum tooth length TL for at least semi-finishing tooth 54B and the finishing tooth 54C. That is to say, the land surface 76 can extend over an entirety of the insert upper surface 28 on the semi-finishing tooth 54B and the finishing tooth 54C.

In accordance with some embodiments of the subject matter of the present application, the finishing tooth 54C can protrude further in the tooth protruding direction TD than the semi-finishing tooth 54B. Likewise, the semi-finishing tooth 54B can protrude further in the tooth protruding direction TD than the roughing tooth 54A.

Reference is now made to FIGS. 1-2 and 9-10, showing the insert holder 24, having a holder longitudinal axis B that defines opposite forward and rearward directions DF, DR. As seen in FIG. 2, the insert holder 24 has a holder forward end 82. The insert holder 24 includes a holder forward end surface 84, formed at the holder forward end 82, and a holder peripheral surface 86, where the holder peripheral surface 86 forms a circumferential boundary of the holder forward end surface 84. The holder peripheral surface 86 extends circumferentially about the holder longitudinal axis B. The holder peripheral surface 86 includes opposite holder top and bottom surfaces 88, 89 and a holder side surface 90 which intersects the holder top and bottom surfaces 88, 89 and also the holder forward end surface 84. The insert holder 24 has a holder median plane H containing the holder longitudinal axis B and which extends mid-way between the holder top and bottom surfaces 88, 89.

It should be noted that use of the terms “forward” and “rearward” throughout the description and claims refer to a relative position in a direction of the holder longitudinal axis B downwards and upwards, respectively, in FIG. 9. In the present disclosure, “forward” is associated with the cutting end of the cutting tool 20. Making reference to FIG. 2 again, the insert holder 24 includes a holder pocket recess surface 92 and a holder pocket opening surface 94 which intersects the holder pocket recess surface 92. In this non-limiting example shown in the drawings, designed for external thread turning, the holder pocket recess surface 92 is part of the holder top surface 88 (at the holder head) and the holder pocket opening surface 94 is part of the holder forward end surface 84. However, the present invention also applies to internal thread turning, where the holder pocket recess surface 92 is part of the holder top surface 88 and the holder pocket opening surface 94 is part of the holder side surface 90 (not shown).

The insert pocket 26 is recessed in the holder pocket recess surface 92 and includes a pocket opening 96 that opens out to the holder pocket opening surface 94. The purpose of the insert pocket 26 is to accommodate the thread turning cutting insert 22 when removably attached to the insert holder 24. The insert pocket 26 includes a pocket base surface 98 and a pocket peripheral surface 100 oriented transversely thereto. The pocket peripheral surface 100 extends partially circumferentially about a pocket central axis E. The pocket peripheral surface 100 forms a partial boundary of the pocket base surface 98. The pocket central axis E can be perpendicular to the pocket base surface 98. Generally speaking, the pocket base surface 98 is the downmost part of the pocket 26.

In accordance with some embodiments of the subject matter of the present application, a shim 102 is releasably attached to the insert holder 24. i.e., the shim 102 is detachable from the insert holder 24. The shim 102 forms part of the insert pocket 26, and thus may be considered part of the insert holder 24.

In accordance with some embodiments of the subject matter of the present application, the insert pocket 26 can include a threaded hole 104, for threadingly receiving the clamping screw. The threaded hole 104 can extend along the pocket central axis E. The threaded hole 104 can open out to the pocket base surface 98.

The pocket peripheral surface 100 includes at least two pocket side surfaces 106. The at least two pocket side surfaces 106 includes first and second pocket side surfaces 106-1, 106-2. In accordance with some embodiments of the subject matter of the present application, the first and second pocket side surfaces 106-1, 106-2 can be connected by a pocket intermediate side surface 107. As seen in FIG. 9, the pocket intermediate side surface 107 can form a gap in the insert pocket 26 which accommodates a non-active thread cutting portion 52. The first pocket side surface 106-1 can extend to the pocket opening 96. The first pocket side surface 106-1 can intersect the holder pocket opening surface 94.

Referring to FIG. 9A, the first and second pocket side surfaces 106-1, 106-2 include first and second pocket side abutment surfaces 108-1, 108-2, respectively. The first and second pocket side abutment surfaces 108-1, 108-2 converge towards each other in a direction opposite the feed direction FD. In accordance with some embodiments of the subject matter of the present application, reverting to FIG. 10, the thread turning cutting insert 22 is seated on an insert seating surface 110, which may be formed on (an upper surface of) the shim 102 (as seen in FIG. 10) or directly on the packet base surface 98. Regardless of where it is formed, the insert seating surface 110 is configured for abutting complementary surfaces on the thread turning cutting insert 22.

A second aspect of the subject matter of the present application relates to the cutting tool 20. In the assembled position of the cutting tool 20, the thread turning cutting insert 22 is removably attached to the insert holder 24 by a fastening member 112.

The cutting teeth are located at the pocket opening 96. The first and second pocket side abutment surfaces 108-1, 108-2 abut two of the at least three insert side abutment surfaces 48.

The insert lower surface 30 abuts the insert seating surface 110 at the insert lower abutment surface 50.

In accordance with some embodiments of the subject matter of the present application, the teeth arrangement direction AD can be co-directional with the feed direction FD. The forward direction DF can be co-directional with the infeed direction ID (when cutting an external thread) or the feed direction FD (when cutting an internal thread). The insert median plane M can be oriented transversely to the holder longitudinal axis B. Making reference to FIG. 10, for any given cutting tooth 54A, 54B, 54C of the active thread cutting portion 52, in a side view of the cutting tool 20 along the feed axis F, the land surface 76 and a tool plane TP oriented parallel to the holder longitudinal axis B (and the holder median plane H) and intersecting the land border line 78 defines an effective land angle β′. The land surface 76 can decrease in distance from the holder median plane H with increasing distance from the land border line 78 at the effective land angle β′ (i.e., the effective land angle β′ is negative when cutting the workpiece). Stated differently, the effective land angle β′ can be less than 0°.

In accordance with some embodiments of the subject matter of the present application, the fastening member 112 can be a clamping screw. The clamping screw can be located in the through hole 36 and threadingly engaged with the threaded hole 104 formed in the pocket base surface 98.

Referring to FIGS. 9 and 10, a third aspect of the subject matter of the present application relates to a method for cutting a thread 114 in a workpiece surface 116 of a workpiece W by means of a cutting tool 20. In this non-limiting example shown in the drawings, the workpiece surface 116 faces radially outwardly in which case the thread 114 is an external thread. Alternatively, the workpiece surface 116 can face radially inwardly in which case the thread 114 is an internal thread (not shown). In this non-limiting example shown in the drawings, the workpiece surface 116 is cylindrical. The workpiece W has a centerline CL defined by a diameter thereof. The thread 114 has a maximum thread depth DT. The tool plane TP can contain the centerline CL.

The method includes the step of rotating the workpiece W about the workpiece rotational axis R in a rotational direction RD. Next, the cutting tool 20 is positioned so that in a view along the workpiece rotational axis R, the tooth nose cutting edge 64 of the roughing tooth 54A touches the workpiece surface 116 at the centerline CL. Referring in particular to FIG. 9, the method further includes sequentially performing a total of two passes P₁, P₂. By moving the cutting tool 20 and/or the workpiece W relative to each other along the feed axis F in the feed direction FD. Preferably, only the cutting tool 20 is moved. During each pass P₁. P₂, a cutting operation is performed on the workpiece. The first pass P₁ is performed at a first pass cutting depth CD₁. The second pass P₂ is performed at a second pass cutting depth CD₂ which is smaller than the first pass cutting depth CD₁.

The first pass cutting depth CD₁ and the second pass cutting depth CD₂ satisfy the condition: 2.5*CD₂≤CD₁≤3.5*CD₂. In accordance with some embodiments of the subject matter of the present application, the first pass cutting depth CD₁ and the second pass cutting depth CD₂ can satisfy the condition: CD₁=3*CD₂. The centerline CL can be oriented in the infeed direction ID (e.g., horizontally). In such a case, the first pass cutting depth CD₁ and the second pass cutting depth CD₂ can satisfy the condition: CD₁+CD₂=DT.

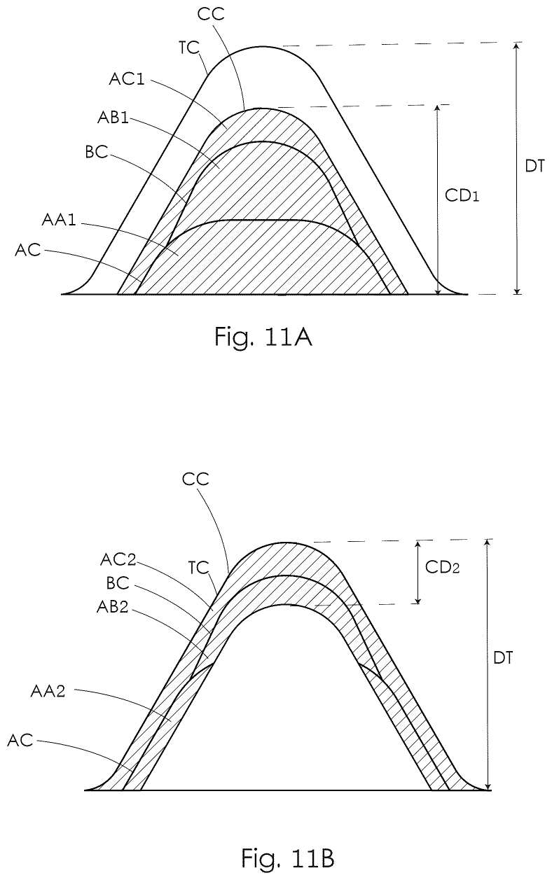

Reference is now made to FIGS. 11A and 11B, showing schematic views of a roughing tooth contour AC, a semi-finishing tooth contour BC and a finishing tooth contour CC superimposed on each other, formed by the roughing tooth 54A, the semi-finishing tooth 54B and the finishing tooth 54C respectively, during the first and second passes, with respect to a final thread contour TC of the thread 114 formed in the workpiece W. The roughing tooth 54A, the semi-finishing tooth 54B and the finishing tooth 54C cut areas AA1, AB1 and AC1 respectively, during the first pass and areas AA2, AB2 and AC2 during the second pass, respectively. It should be noted that finishing tooth contour CC during the second pass and the final thread contour TC coincide with each other. It should further be noted that one feature of the present arrangement of the areas AA1-AC2 is that the cutting load is distributed relatively evenly which allows for the thread to be formed in only two passes.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed is:

1. A thread turning cutting insert (22) having an insert central axis (C) and comprising:
opposite insert upper and lower surfaces (28, 30) and an insert peripheral surface (32) extending therebetween about the insert central axis (C); and
at least one thread cutting portion (52) comprising:
three spaced apart, non-identical cutting teeth (54A, 54B, 54C) which differ from one another in shape and/or size, the three cutting teeth (54A, 54B, 54C) protruding outwardly from the insert peripheral surface (32) in a common tooth protruding direction (TD), the three cutting teeth (54A, 54B, 54C) being arranged sequentially along a teeth arrangement axis (A) which defines a teeth arrangement direction (AD) and comprising a roughing tooth (54A), a finishing tooth (54C) and a semi-finishing tooth (54B) located therebetween, the roughing tooth (54A) being forward of the semi-finishing tooth (54B) and the semi-finishing tooth (54B) being forward of the finishing tooth (54C) with respect to the teeth arrangement direction (AD);
three cutting edges (58) formed at the intersection of the insert upper surface (28) and the insert peripheral surface (32), each cutting edge (58) being located on a respective cutting tooth (54A, 54B, 54C);
a chip forming groove (70) recessed in the insert upper surface (28), the chip forming groove (70) extending along a groove axis (G) and comprising opposite near-flank and far-flank groove surfaces (72A, 72B) which converge towards each other, the near-flank groove surface (72A) being closer to the three cutting teeth (54A, 54B, 54C) than the far-flank groove surface (72B); and
three planar land surfaces (76), each extending from an entire length of a respective cutting edge (58) to the near-flank groove surface (72A), thereby defining a land border line (78).

2. The thread turning cutting insert (22) according to claim 1, wherein:
at least one cutting tooth has a tooth protruding axis (T) which defines the common tooth protruding direction (TD), and
the at least one thread cutting portion (52) has a border plane (P) oriented perpendicular to the tooth protruding axis (T) which contains the land border line (78).

3. The thread turning cutting insert (22) according to claim 2, wherein:
the groove axis (G) is oriented parallel to the border plane (P).

4. The thread turning cutting insert (22) according to claim 2, wherein, in a top view of the at least one thread cutting portion (52):
the roughing tooth (54A) and the semi-finishing tooth (54B) are spaced apart by a roughing tooth gap (56A);
the semi-finishing tooth (54B) and the finishing tooth (54C) are spaced apart by a semi-finishing tooth gap (56B);
the border plane (P) intersects at least one of the roughing tooth gap (56A) and the semi-finishing tooth gap (56B); and
the land border line (78) is non-continuous.

5. The thread turning cutting insert (22) according to claim 4, wherein:
the border plane (P) intersects the roughing tooth gap (56A); and
the land surfaces (76) on the roughing tooth (54A) and the semi-finishing tooth (54B) are spaced apart.

6. The thread turning cutting insert (22) according to claim 1, wherein:
the cutting edge (58) on each cutting tooth (54A, 54B, 54C) comprises two tooth flank cutting edges (62) and a tooth nose cutting edge (64) extending therebetween.

7. The thread turning cutting insert (22) according to claim 6, wherein:
the two tooth flank cutting edges (62) on all the three cutting teeth (54A, 54B, 54C) are straight.

8. The thread turning cutting insert (22) according to claim 6, wherein:
the tooth nose cutting edge (64) on the roughing tooth (54A) comprises two tooth nose cutting edge extremities (66) and a tooth nose cutting edge mid-potion (68) extending therebetween; and
the tooth nose cutting edge mid-potion (68) is straight.

9. The thread turning cutting insert (22) according to claim 6, wherein:
the tooth nose cutting edge (64) on the semi-finishing tooth (54B) is defined by a semi-finishing radius (RB);
the tooth nose cutting edge (64) on the finishing tooth (54C) is defined by a finishing radius (RC); and
the finishing radius (RC) is less than the semi-finishing radius (RB).

10. The thread turning cutting insert (22) according to claim 6, wherein:
the tooth flank cutting edges (62) on the roughing tooth (54A) define a roughing angle (θA);
the tooth flank cutting edges (62) on the semi-finishing tooth (54B) define a semi-finishing angle (θB);
the tooth flank cutting edges (62) on the finishing tooth (54C) define a finishing angle (θC); and
the semi-finishing angle (θB) is less than the roughing angle (OA) and the finishing angle (θC).

11. The thread turning cutting insert (22) according to claim 6, wherein:
at least one cutting tooth has a tooth protruding axis (T) which defines the common tooth protruding direction (TD),
each cutting tooth (54A, 54B, 54C) has a minimum tooth length (TL) measured in the tooth protruding direction (TD) along the tooth protruding axis (T); and
for any given cutting tooth (54A, 54B, 54C), the land surface (76) extends between the two tooth flank cutting edges (62) and also extends from the tooth nose cutting edge (64), in a direction opposite the tooth protruding direction (TD), further than 50% of the minimum tooth length (TL).

12. The thread turning cutting insert (22) according to claim 1, wherein:
the finishing tooth (54C) protrudes further in the tooth protruding direction (TD) than the semi-finishing tooth (54B); and
the semi-finishing tooth (54B) protrudes further in the tooth protruding direction (TD) than the roughing tooth (54A).

13. The thread turning cutting insert (22) according to claim 1, wherein:
the land surfaces (76) on the three cutting teeth (54A, 54B, 54C) are co-planar; and
the land border line (78) is a straight line.

14. The thread turning cutting insert (22) according to claim 1, wherein:
the at least one thread cutting portion (52) comprises exactly three cutting teeth (54A, 54B, 54C).

15. The thread turning cutting insert (22) according to claim 1, wherein:
the thread turning cutting insert (22) comprises at least three identical thread cutting portions (52) circumferentially spaced apart about the insert central axis (C);
the insert peripheral surface (32) comprises at least three insert side surfaces (44) and at least three insert corner surfaces (46) alternating therewith, the at least three insert side surfaces (44) comprising at least three insert side abutment surfaces (48), each insert side surface (44) having a respective insert side abutment surface (48) located thereon; and
in each thread cutting portion (52), the three cutting teeth (54A, 54B, 54C) protrude outwardly in said common tooth protruding direction (TD), from a respective insert corner surface (46) or a respective insert side surface (44).

16. The thread turning cutting insert (22) according to claim 15, wherein:
in each thread cutting portion (52), the three cutting teeth (54A, 54B, 54C) protrude outwardly from a respective insert corner surface (46).

17. The thread turning cutting insert (22) according to claim 15, wherein:
the at least three insert side surfaces (44) comprise exactly three insert side surfaces (44); and
the at least three insert corner surfaces (46) comprise exactly three insert corner surfaces (46).

18. The thread turning cutting insert (22) according to claim 1, wherein:
the thread turning cutting insert (22) has an insert plane (IP) oriented perpendicular to the insert central axis (C) and intersecting the land border line (78);
the chip surface (74) and the insert plane (IP) define a rake angle (α); and
each land surface (76) and the insert plane (IP) define a land angle (β), the land angle (β) being less than the rake angle (α).

19. The thread turning cutting insert (22) according to claim 18, wherein:
the land angle (β) satisfies the condition: 0°≤β≤5°.

20. The thread turning cutting insert (22) according to claim 19, wherein:
the land angle (β) is equal to 0°.

21. The thread turning cutting insert (22) according to claim 1, wherein:
at least one cutting tooth has a tooth protruding axis (T) which defines the common tooth protruding direction (TD); and
the insert central axis (C), the teeth arrangement axis (A) and the tooth protruding axis (T) are mutually perpendicular to each other.

22. A cutting tool (20) having a feed axis (F) defining a feed direction (FD), and an infeed axis (I) oriented transversely to the feed axis (F) and defining an infeed direction (ID), the cutting tool (20) comprising:
an insert holder (24) having a holder longitudinal axis (B) defining opposite forward and rearward direction (DF, DR), the insert holder (24) comprising an insert pocket (26) located at a forward end thereof; and
a thread turning cutting insert (22), in accordance with claim 1, releasably retained in the insert pocket (26).

23. The cutting tool (20), according to claim 22, wherein:
the thread turning cutting insert (22) has an insert median plane (M) oriented perpendicular to the insert central axis (C) and extending mid-way between the insert upper and lower surfaces (28, 30);
the insert median plane (M) is oriented transversely to the holder longitudinal axis (B);
for any given cutting tooth (54A, 54B, 54C) of an active thread cutting portion (52), in a side view of the cutting tool (20) along the feed axis (F), the land surface (76) and a tool plane (TP) oriented parallel to the holder longitudinal axis (B) and intersecting the land border line (78) defines an effective land angle (β′); and
the effective land angle (β′) is less than 0°.

24. A method for cutting a thread (114) in a workpiece surface (116) on a workpiece (W) by means of a cutting tool (20) in accordance with claim 22, wherein:
the thread (114) has a thread depth (DT);
the workpiece (W) has a centerline (CL) defined by a diameter thereof; and
the cutting edge (58) on each cutting tooth (54A, 54B, 54C) comprises two tooth flank cutting edges (62) and a tooth nose cutting edge (64) extending therebetween;
the method comprising:
rotating the workpiece (W) about a workpiece rotational axis (R) in a rotational direction (RD);
positioning the cutting tool (20) so that, in a view along the workpiece rotational axis (R), the tooth nose cutting edge (64) of the roughing tooth (54A) touches the workpiece surface (116) at the centerline (CL);
performing a first pass (P1) by moving the cutting tool (20) and/or the workpiece (W) relative to each other along the feed axis (F) in the feed direction (FD), the first pass (P1) being performed at a first pass cutting depth (CD₁);
performing a second pass (P2) by moving the cutting tool (20) and/or the workpiece (W) relative to each other along the feed axis (F) in the feed direction (FD), the second pass (P₂) being performed at a second pass cutting depth (CD₂); wherein:
the first pass cutting depth (CD₁) and the second pass cutting depth (CD₂) satisfy the condition: 2.5*CD₂≤CD₁≤3.5*CD₂.

25. The method for cutting a thread (114), according to claim 24, wherein:
the first pass cutting depth (CDI) and the second pass cutting depth (CD₂) satisfy the condition: CD₁=3*CD₂.

26. The method for cutting a thread (114), according to claim 24, wherein:
the centerline (CL) is oriented in the infeed direction (ID); and
the first pass cutting depth (CD₁) and the second pass cutting depth (CD₂) satisfy the condition: CD₁+CD₂=DT.
